(19) United States
(12) Patent Application Publication
(10) Pub. No.: US 2009/0100357 A1
(43) Pub. Date: Apr. 16, 2009

(54) Systems and methods for visually selecting information

(76) Inventors: Alessio Signorini, Pisa (IT); Antonio Gulli, Pisa (IT)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/974,386

(22) Filed: Oct. 11, 2007

(51) Int. Cl. G06F 3/048

(52) U.S. Cl. 715/760; 715/781

(57) ABSTRACT

Systems and methods for presenting information are disclosed. Users are presented with a selectable representation of the information on a webpage. Users can access additional information and/or another web page by mousing over the selectable representation. The mouse over includes pointing the mouse pointer over the selectable representation for a predetermined amount of time.

### FIELD

This invention relates to the field of presentation of information on the Internet and, in particular, to systems and methods for visually selecting information.

### BACKGROUND

The Internet is a global network of computer systems and websites. These computer systems include a variety of documents, files, databases, and the like, which include information covering a variety of topics. Internet users are more frequently using the Internet as a source for information. In particular, Internet users are using the Internet as a source of news information, displacing conventional newspapers as their source for news information.

Typically, webpages display information and links to other webpages or websites. If a user wants to access the links, the user must move their mouse pointer over the link, and mouse click at least once or twice. Moreover, once at the linked webpage, the user must select the back button to return to the original webpage.

In the case of news information, users are typically presented with a website listing the titles of several representative articles, without any additional information. If a user wants to learn more about a story associated with a title, the user typically must select the article's title, a link, and is redirected to a webpage having the entire news article. The user is not able to access an abstract or other relevant information about the article, without accessing the entire article.

### SUMMARY

Systems and methods for presenting electronic information are disclosed herein.

In one embodiment, the method includes clustering news information according to a topic to create topic clusters, each topic cluster having a plurality of news information objects associated with the topic cluster; presenting at least one of the news information objects associated with the topic clusters in a user interface, each presenting news information object having a selectable portion; and receiving a user selection of the at least one of the news information objects, the user selection being a mouse over of the selectable portion.

The method may also include presenting the user with news information associated with the selected topic clusters.

The method may also include associating a news information object with a topic cluster.

The topic cluster may be part of a topic chain, and the news information object may be associated with the topic chain.

The news information object may consist essentially of a representative image and a representative title.

The mouse over may include detecting a pointer over the news information object for a predetermined amount of time.

The method may also include presenting comprises presenting the user with an article from a selected topic cluster.

The news information object may be an anchor. The news information object may be a link to a webpage.

In another embodiment, the method includes allowing a user to access a collection of images, each image associated with at least one news article; receiving a user selection of an image from the collection of images, wherein the user selection is a mouse over of the image; and presenting the user with a plurality of news objects associated with the selected object.

Each image in the collection of images may be associated with a representative title, the user selecting either or both of the one or more images or representative titles.

The method may also include presenting comprises presenting an abstract of a selected news article and a link to access the entire article.

The mouse over may include detecting a pointer over the image for a predetermined amount of time.

The plurality of news objects may be images.

The image may be an anchor. The image may be a link to a webpage.

In yet another embodiment, the method may include providing a first webpage having a selectable object therein, the selectable object being a link to a second webpage; receiving a user selection of the selectable object, the user selection being a mouse over of the selectable object; and providing the second webpage to the user in response to the user selection.

The second webpage may be presented in a new window.

The user may be automatically redirected from the first webpage to the second webpage in response to the user selection.

The mouse over may include detecting a pointer over the selectable object for a predetermined amount of time.

The first webpage and second webpage may be associated with the same website. The first webpage may be associated with a first website and the second webpage may be associated with a second website.

### BRIEF DESCRIPTION OF THE DRAWINGS

The invention is described by way of example with reference to the accompanying drawings, wherein:

FIG. 1 is a block diagram illustrating a system in accordance with one embodiment of the invention;

FIG. 2 is a block diagram illustrating a method of clustering news information in accordance with one embodiment of the invention;

FIG. 2A is a block diagram illustrating organization of news information in accordance with one embodiment of the invention;

FIG. 2B is a block diagram illustrating organization of news information in accordance with one embodiment of the invention;

FIG. 3 is a schematic view of a user interface for presenting news information in accordance with one embodiment of the invention;

FIG. 4 is a screen shot of an exemplary user interface for presenting visual news information in accordance with one embodiment of the invention;

FIG. 5 is a screen shot illustrating clickless selection in accordance with one embodiment of the invention;

FIG. 6A is a screen shot of an exemplary user interface having news information and an advertisement in accordance with one embodiment of the invention;

FIG. 6B is a screen shot illustrating clickless selection in accordance with one embodiment of the invention;

FIG. 7A is a screen shot of an exemplary user interface having products for purchase in accordance with one embodiment of the invention;

FIG. 7B is a screen shot illustrating clickless selection in accordance with one embodiment of the invention;

FIG. 8A is a screen shot of an exemplary user interface in accordance with one embodiment of the invention;

FIG. 8B is a screen shot illustrating clickless selection in accordance with one embodiment of the invention;

FIG. 9A is a screen shot of an exemplary user interface in accordance with one embodiment of the invention;

FIG. 9B is a screen shot illustrating clickless selection in accordance with one embodiment of the invention;

FIG. 10A is a screen shot of an exemplary user interface in accordance with one embodiment of the invention;

FIG. 10B is a screen shot illustrating clickless selection in accordance with one embodiment of the invention;

FIG. 11 is a screen shot illustrating clickless selection in accordance with one embodiment of the invention; and

FIG. 12 is a block diagram of a digital processing system in accordance with one embodiment of the present invention.

### DETAILED DESCRIPTION

Embodiments of the present invention related to clickless selection of links, data, etc. in a website. Clickless selection, as described herein, may be used in any application for which a “point and click” selection is typically used.

The Internet is made up of different web pages stored in a distributed set of independent servers. Each web page can contain one or more links to other web pages. The Internet has been traditionally described as a direct graph WG=(WN,WE), where nodes WN represent the web pages and direct edges WE represent the oriented hyperlink between pages. Each edge is annotated by an anchor. The anchor is defined as the text portion surrounding a hyperlink. Users can navigate among pages using a browser, such as Microsoft's Internet Explorer, and selecting the anchors. As described above, users have conventionally been required to point to the anchor with a mouse and click the mouse button to make a selection (i.e., point and click or double click selections)

In accordance with embodiments of the present invention, the user can select the anchors without clicking the anchors by moving the mouse over the link. The mouse is represented by a mouse pointer. The pointer or mouse is positioned over the anchor for a predetermined amount of time. The predetermined amount of time may be several seconds. For example, the predetermined amount of time may be any time or range of times between about 1 second and 30 seconds. It will be appreciated that the amount of time may be smaller than 1 second or greater than 30 seconds.

When a user mouses over an anchor on a webpage, the user is redirected to the hyperlink associated with the anchor. In one embodiment, the user is redirected to the hyperlink associated with the anchor using a pop-up window in response to a mouse over selection.

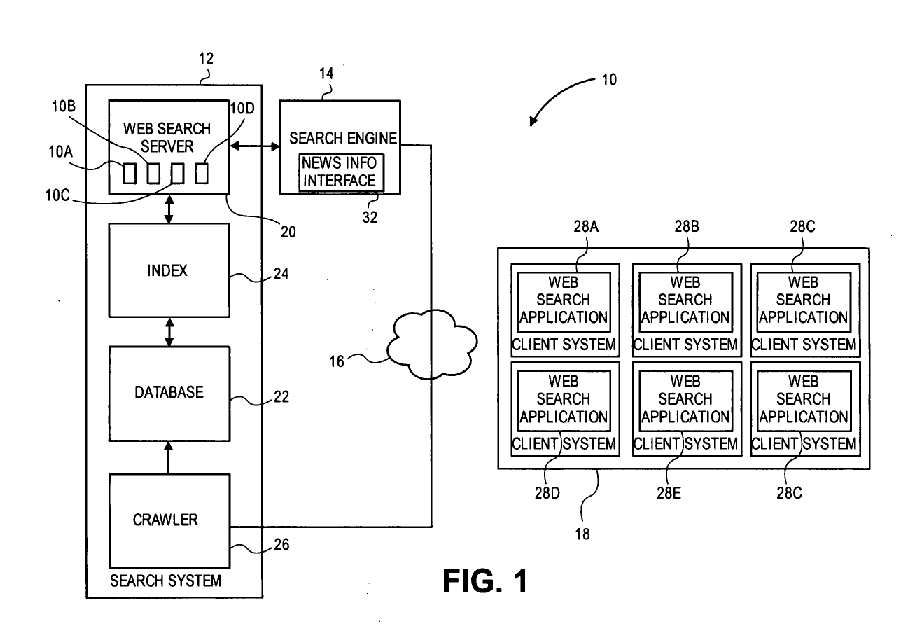

FIG. 1, of the accompanying drawings, shows a network system 10 which can be used in accordance with one embodiment of the present invention. The network system 10 includes a search system 12, a search engine 14, a network 16, and a plurality of client systems 18. The search system 12 includes a server 20, a database 22, an indexer 24, and a crawler 26. The plurality of client systems 18 includes a plurality of web applications 28a-f, located on each of the plurality of client systems 18. The server 20 may include a plurality of databases 30a-d. The search engine 14 may also include a news information interface 32.

The server 12 is connected to the search engine 14. The search engine 14 is connected to the plurality of client systems 18 via the network 16. The server 20 is in communication with the database 22 which is in communication with the indexer 24. The indexer 24 is in communication with the crawler 26. The crawler 26 is capable of communicating with the plurality of client systems 18 via the network 16 as well.

The web search server 20 is typically a computer system, and may be an HTTP server. It is envisioned that the search engine 14 may be located at the web search server 20. The web search server 20 typically includes at least processing logic and memory.

The indexer 24 is typically a software program which is used to create an index, which is then stored in storage media. The index is typically a table of alphanumeric terms with a corresponding list of the related documents or the location of the related documents (e.g., a pointer). An exemplary pointer is a Uniform Resource Locator (URL). The indexer 24 may build a hash table, in which a numerical value is attached to each of the terms. The database 22 is stored in a storage media, which typically includes the documents which are indexed by the indexer 24. The index may be included in the same storage media as the database 22 or in a different storage media. The storage media may be volatile or non-volatile memory that includes, for example, read only memory (ROM), random access memory (RAM), magnetic disk storage media, optical storage media, flash memory devices and zip drives.

The crawler 26 is a software program or software robot, which is typically used to build lists of the information found on web sites. Another common term for the crawler 26 is a spider. The crawler 26 typically searches web sites on the Internet and keeps track of the information located in its search and the location of the information.

The network 16 is a local area network (LAN), wide area network (WAN), a telephone network, such as the Public Switched Telephone Network (PSTN), an intranet, the Internet, or combinations thereof.

The plurality of client systems 18 may be mainframes, minicomputers, personal computers, laptops, personal digital assistants (PDA), cell phones, and the like. The plurality of client systems 18 are capable of being connected to the network 16. Web sites may also be located on the client systems 18. The web application 28a-f is typically an Internet browser or other software. It will be appreciated that the number of client systems 18 is not limited to the number shown.

The databases 30a-d are stored in storage media located at the server 20. The storage media may be volatile or non-volatile memory that includes, for example, read only memory (ROM), random access memory (RAM), magnetic disk storage media, optical storage media, flash memory devices and zip drives. It will be appreciated that a smaller number or greater number of databases may be provided than those illustrated.

In use, the crawler 26 crawls websites, such as the websites of the plurality of client systems 18, to locate information on the web. The crawler 26 employs software robots to build lists of the information. The crawler 26 may include one or more crawlers to search the web. The crawler 26 typically extracts the information and stores it in the database 22. The indexer 24 creates an index of the information stored in the database 22. Alternatively, if a database 22 is not used, the indexer 24 creates an index of the located information and the location of the information on the Internet (typically a URL).

When a user of one of the plurality of client systems 18 enters a search on the web application 28, the search is communicated to the search engine 14 over the network 16. The search engine 14 communicates the search to the server 20 at the search system 12. The server 20 accesses the index and/or database to provide a search result, which is communicated to the user via the search engine 14 and network 16.

If a user of one of the plurality of client systems 18 accesses the news information interface 32 through the web search application 28, the search engine 14 still communicates the search to the server 20, which provides a search result. The search result may be obtained from either or both the web index and a dedicated news information index. The search result is typically searchable news information. As will be described hereinafter, the news information is searchable using a search query, such as a keyword or natural language search, or using a browser.

In one embodiment, the search engine may be a news engine. A news engine is a search engine specialized in searching and browsing news articles, blog postings and related user comments. As discussed above, the articles and other related news information may be located by crawling of web pages or documents available on the Internet. In addition, pull technologies, such as RSS, Atom feeds, XML and the like may be used to locate the news information. News information can also be obtained through direct submission by users or companies. News information may include news articles, blogs, RSS/Atom feeds, video news, photographs, audio content, a stream of textual information enriched with other media content, or any other media content. Each article may have one or more multimedia elements associated therewith. Exemplary multimedia elements include images, videos, audio content and the like. Each article may also be classified under a category. Exemplary categories include World, National Stories, Politics, Business, Sports, Entertainment, Science, Health, Technology, and the like. In one embodiment, the news information is classified by the search engine into categories by a classifier.

In embodiments wherein the search engine is a news search engine, the crawler 26 may search the web for news information and store the news information and/or properties of the news information in index and/or database, and/or in a dedicated news index and/or news database (not shown). It will be appreciated that different crawlers may be provided for different types of news information. In one embodiment, a separate crawler is provided for each of news articles, blogs, etc.

Searchable news information, as will be described hereinafter, may be stored in one or more of databases 30a-d. The news information interface 32 may be connected to the server, one or more databases 30a-d having news information stored therein, database 22 and/or indexer 24. In one embodiment, each database 30a-d includes news information in a particular category or classification. In another embodiment, each database 30a-d includes different types of news information (e.g., articles, blogs, images, etc.).

In one embodiment, the news search system is one aspect of a multi-purpose search system. In another embodiment, the news search system may be an independent search system. In one embodiment, the news search system includes a dedicated news crawler, news indexer, news database, news server, and the like, with the news interface being directly connected to the news search system.

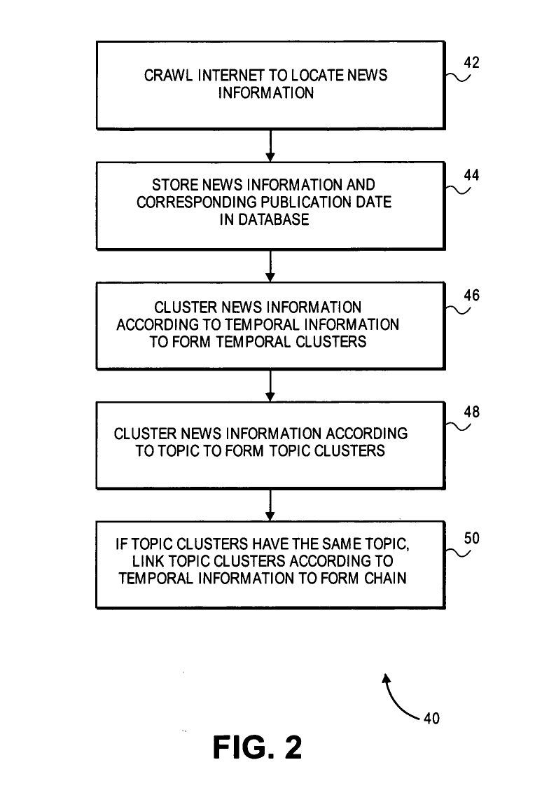

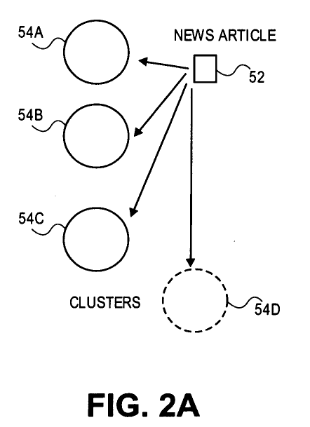

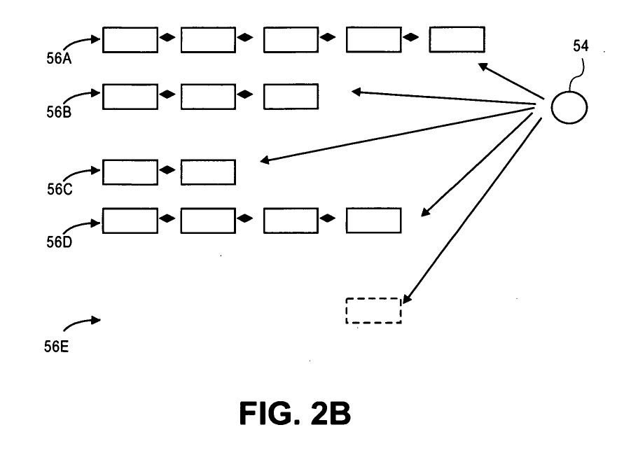

FIG. 2 illustrates a method 40 for clustering a stream of information in accordance with one embodiment of the invention. Clustering the stream of information allows news information related to the same story or topic to be grouped together. It will be appreciated that other methods for clustering a stream of information may be used and the process may vary from that illustrated.

The method 40 begins at block 42, where a crawler, such as crawler 16 (FIG. 1) or a dedicated news information crawler, searches the Internet to locate news information. At block 44, located news information (and/or properties about the news information) is stored in an index and/or database. At block 46, the news information is clustered according to temporal information to form temporal clusters. At block 48, the temporal clusters are clustered according to topic to form topic clusters. At block 50, if topic clusters have the same topic, the topic clusters are linked together to form a chain according to the temporal information.

FIG. 2A illustrates an exemplary process for identifying a topic cluster for a news article. For each news article 52, the system determines whether an existing cluster 54a-c is related to the same topic as the news article 52. If the news article 52 is related to the same topic as one of the existing clusters 54a-c, the news article 52 is added to the corresponding existing cluster. If the news article 52 is not related to the same topic as one of the existing clusters 54a-c, a new cluster 54d is formed for the topic corresponding to the news article 52.

FIG. 2B illustrates an exemplary process for identifying a topic chain for a cluster. For each cluster 54, the system determines whether an existing chain 56a-d is related to the same topic as the cluster 54. If the cluster 54 is related to the same topic as one of the existing chains 56a-d, the cluster 54 is added to the corresponding existing chain. If the chain 54 is not related to the same topic as one of the existing clusters 56a-d, a new chain 56e is formed for the topic corresponding to cluster 54.

In one embodiment, temporal clustering is carried out on daily basis. In this case, the chains of previous days may be consolidated and stored off-line for efficiency reasons. The clusters formed for the current day may be created every m minutes, for example, and dynamically merged with the offline chains.

Each of the clusters and/or chains is typically stored in the external memory. Typically, the external memory includes a database, such as one or more of databases 30a-d, and/or an index, as described hereinabove.

The temporal information used to cluster the information is typically the publication date and/or time, posting date and/or time, clustering date and/or time (i.e., when the news information is clustered) or crawling date and/or time (i.e., when the news information is located, indexed and/or stored by the crawler).

The process for clustering a stream of information typically occurs periodically. The process for classifying a stream of information may also occur periodically. The crawler 26 typically locates more news information each time it searches the Internet; thus, the above process may occur concurrently with crawling. Alternatively, a window of time ω, such as an hour, a day, a week, etc. is selected for clustering. It will also be appreciated that news stories in different categories may be clustered at different periods of time and, thus, different periods of time can be selected for different news categories. For example, business news is typically updated more frequently than world news; thus, the time increment for clustering business news may be more frequent (e.g., every five minutes) than the time increment for clustering world news (e.g., every hour).

A clustering algorithm is used to cluster the information. An exemplary clustering algorithm is disclosed in U.S. patent application Ser. No. 11/417,405, filed May 3, 2006, the entirety of which is hereby incorporated by reference. In one embodiment, the news information is clustered according to a selected window of time ω. New clusters can be periodically linked to chains or new topic clusters can be identified periodically. The new clusters are compared to other clusters to discover similarities in topic. When similarities are found among clusters in different time windows, the clusters are linked together to form a chain or are added to a preexisting chain. This comparison with clusters in previous time windows can stop if no similar information is found for a period of time proportional to the extension of the current cluster or to an extension of the chain. The chain of clusters is organized in a hierarchy according to the temporal information of each cluster: the most recent cluster is typically displayed at the top of the chain and the oldest cluster is typically displayed at the bottom of the chain.

Clusters may be represented by visual and nonvisual information or objects. In one embodiment, the clusters are represented by a multimedia element or visual or nonvisual information or objects associated with the news information. For example, the visual information may include an image or video associated with the cluster. The nonvisual information may be a title for the cluster. The title of the cluster may be the complete title of an article in the cluster, a substring of the title of a cluster's article, a novel title automatically generated using the titles of the articles in the cluster, or the like. In one embodiment, the clustering algorithm includes associating the visual and/or nonvisual information with the cluster. It will be appreciated that a chain may be similarly represented by visual and nonvisual information.

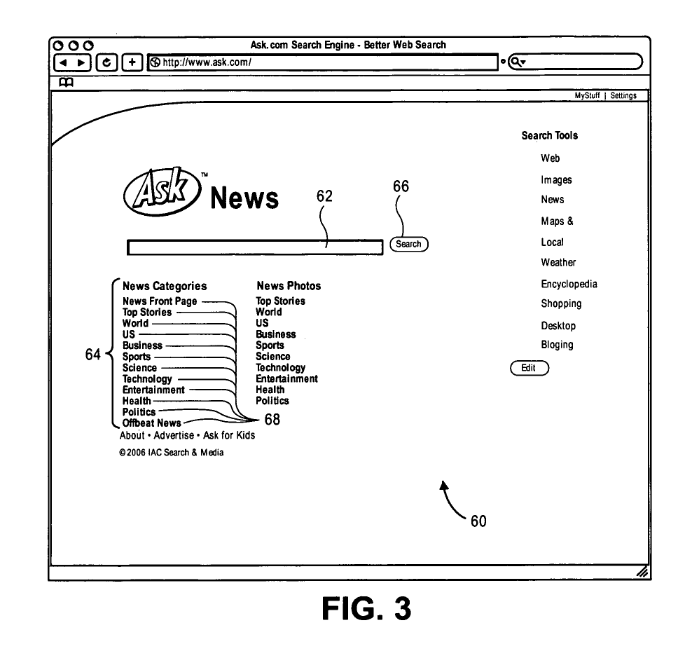

FIG. 3 shows an exemplary user interface 60 for selecting news information in accordance with one embodiment of the present invention. The user interface 60 may be connected to or otherwise related to the news information interface 32 (FIG. 1).

The illustrated user interface 60 includes a search box 62 and a list of selectable news categories 64.

The search box 62 may also include a selectable button 66. Users of the user interface 60 enter a search query into the search box 62 and select the selectable button 66 to search for news information related to the search query. The search query may be, for example, a keyword search or a natural language search.

The list of selectable news categories 64 may include selectable links 68 corresponding to each of the categories in the list of selectable news categories 64. Users of the user interface 60 select one of the selectable links 68 from the list of selectable news categories 64 to link to browsable news information relating to the selected news category. It will be appreciated that any number or type of news categories may be presented to a user for selection. For example, the illustrated news categories 64 include top stories, world, U.S., business, sports, science, technology, health, politics, entertainment and offbeat news.

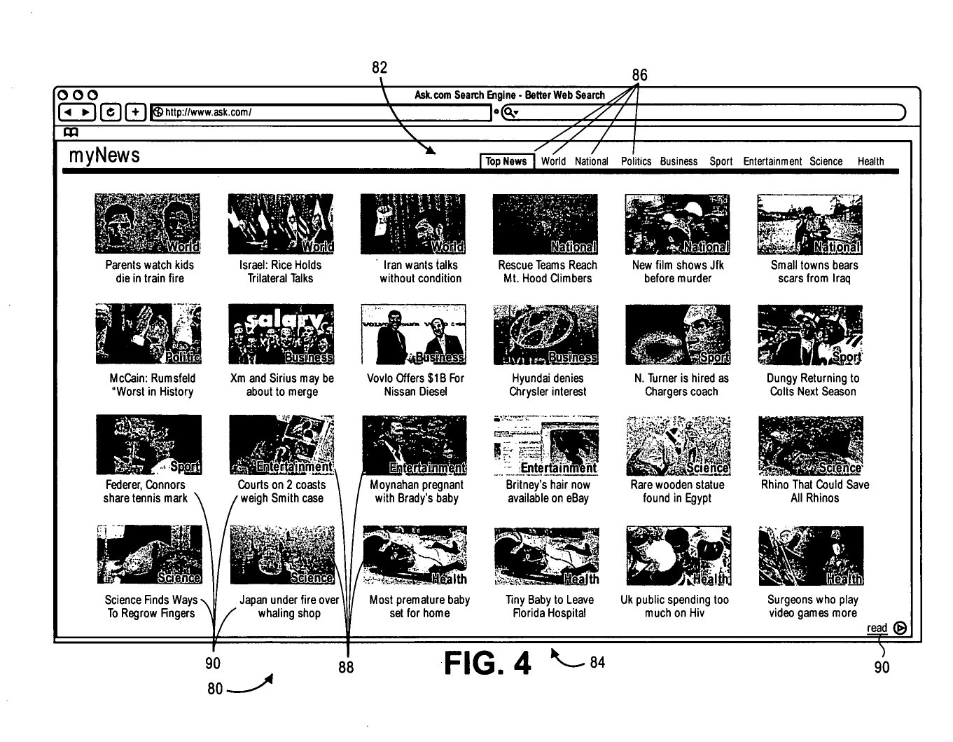

FIG. 4 is a user interface 80 for presenting news information in accordance with one embodiment of the invention. In one embodiment, the user interface 80 is accessible from the interface 60 of FIG. 3. For example, if a user selects a category link 68, the category link 68 redirects the user to user interface 80. In another embodiment, a user automatically arrives at user interface 80 when they access the website associated with the news search system.

In FIG. 4, the user interface 80 includes a header 82 and a main portion 84. The header 82 includes a plurality of tabs 86. Each of the illustrated tabs corresponds to a news category. For example, in FIG. 4, the tab corresponding to “Top News” is highlighted.

A plurality of images 88 are shown in the main portion 84. The images 88 also have text 90 associated therewith. Each of these images 88 and corresponding text 90 is associated with a news article, news cluster or news article. The images 88, text 90, and associated news article, cluster or chain are from the selected category, corresponding to the selected tab 86.

The interface 80 provides a visual interface. The visual interface includes a collection of images (or videos) associated with the articles, cluster, and/or chain. The visual information may also include some text therewith, such as a title of the article, cluster, and/or chain, or certain keywords associated with the visual information.

In use, a user reviews the images 88 and text 90 in the interface 80. The user can select the images 88 and text 90 if the user wants to access more information about the corresponding story (e.g., article, cluster or chain). The user can also select images 88 from different categories by selecting the tab 86 to access images 88 associated with the selected category.

As discussed above, articles may be clustered into clusters and/or chains. A cluster of articles or a chain of articles are articles written about a common topic, and a chain is an ordered set of clusters of articles with the same topic as the article/cluster with which the chain is associated.

Each story or topic may be represented by multiple objects. These objects may include a representative title, a snippet of the main article, an authoritative multimedia object (e.g., image, video, audio content) associated with the cluster, a cluster of related news article(s), an authoritative title of past clusters of related news articles, a cluster of related blogs and/or blog postings, authoritative entities (e.g., people, companies, places, events, etc.) involved in the story, comments posted by users on the topic, and the like.

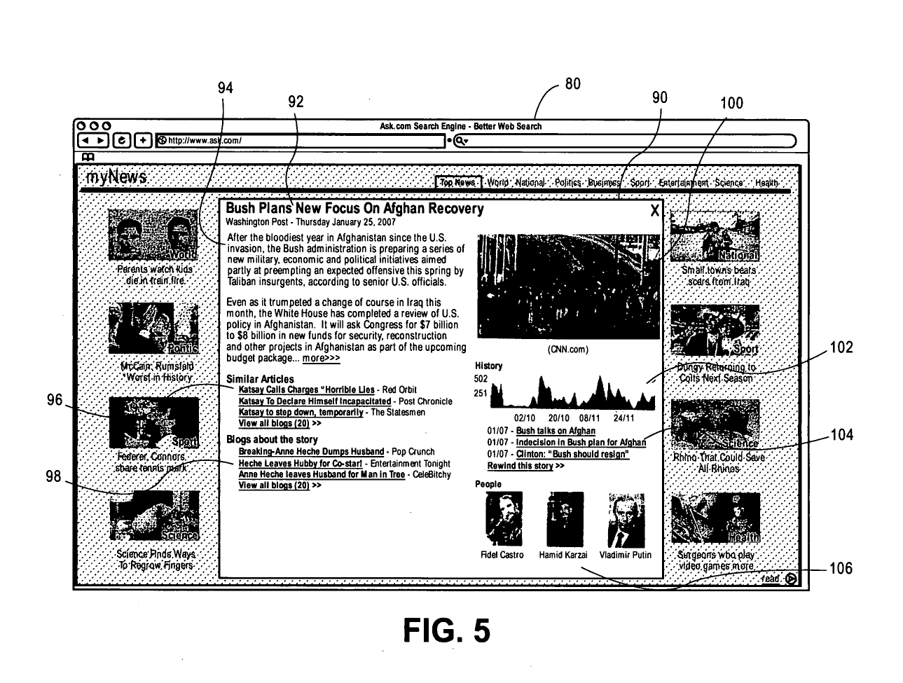

In one embodiment, when the user selects an image from the collection of images 88, a window 90 is presented over the images 88, as shown in FIG. 5.

In one embodiment, the user selects an image by mouse-ing over the image 88. A mouse over occurs when a user holds a mouse pointer over the image for a predetermined amount of time. For example, the user may be required to hold the pointer over the image for 5 seconds to access the news information associated with a particular image. It will be appreciated that the actual amount of time may be any value or range of values between about 1 second and 30 seconds, less than 1 second or greater than 30 seconds. Thus, the user is able to select an image without clicking a button on the mouse or touch pad. The selection is, therefore, clickless.

In one embodiment, each image 88 in the user interface 80 of FIG. 4 is an anchor. The zero-click or clickless navigation can be used to access news information, advertisements, web pages, etc. Users are therefore able to visually select information in a web page.

The illustrated window 90 includes the cluster or chain information associated with the selected image, such as the associated news articles, past correlated clusters, blog postings, user comments, images, videos and sounds (i.e., news information associated with, for example, a cluster). For example, in FIG. 5, the window 90 includes a title 92, abstract of the article 94, similar articles 96, blogs 98, image 100, histogram 102, history 104, and authoritative people 106.

In FIG. 5, the user interface 80 is lowlighted and the window 90 is highlighted. It will be appreciated that the window 90 need not be highlighted as illustrated. In addition, the user interface 80 need not be visible.

Each of the news information objects 92-106 may also be selected. In one embodiment, the news information objects 92-106 are also selected without clicking (i.e., mouse over). For example, if a user selects a title from a selected cluster, the user may be then access the entire article. In another example, if a user selects a link associated with a person related to the cluster, the user may then access a description of the person. It will be appreciated that each of the title, articles images, people, etc., can be selected via a mouse over to access the information without clicking.

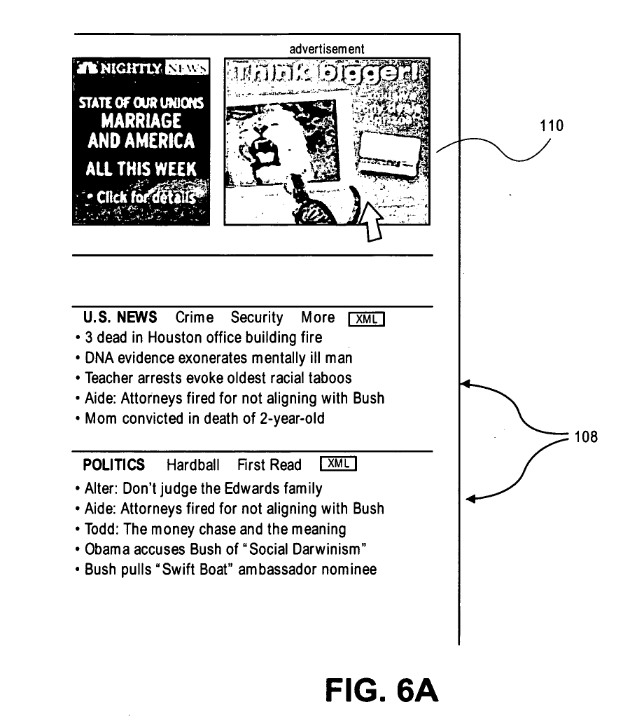

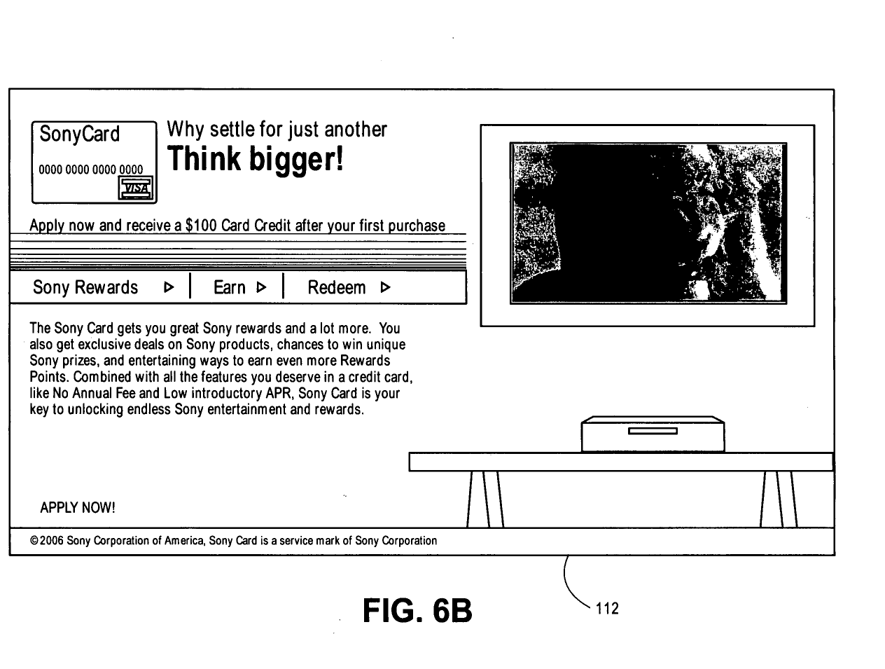

FIGS. 6A-6B illustrate clickless selection in accordance with one embodiment of the invention. In FIG. 6A, a user interface includes news information 108 and advertisements 110. A user can select, without clicking (i.e., mouse over), the news information 108 or the advertisement 110. If the user selects the advertisement 108, the user may be redirected to the website 112 associated with the advertisement, as shown in FIG. 6B.

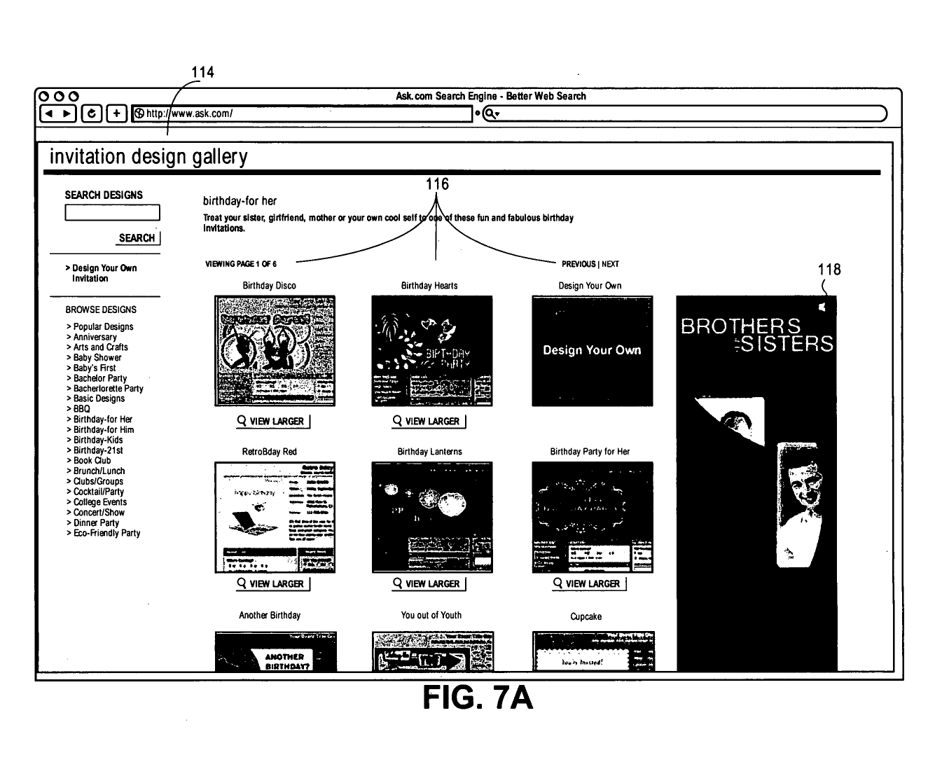

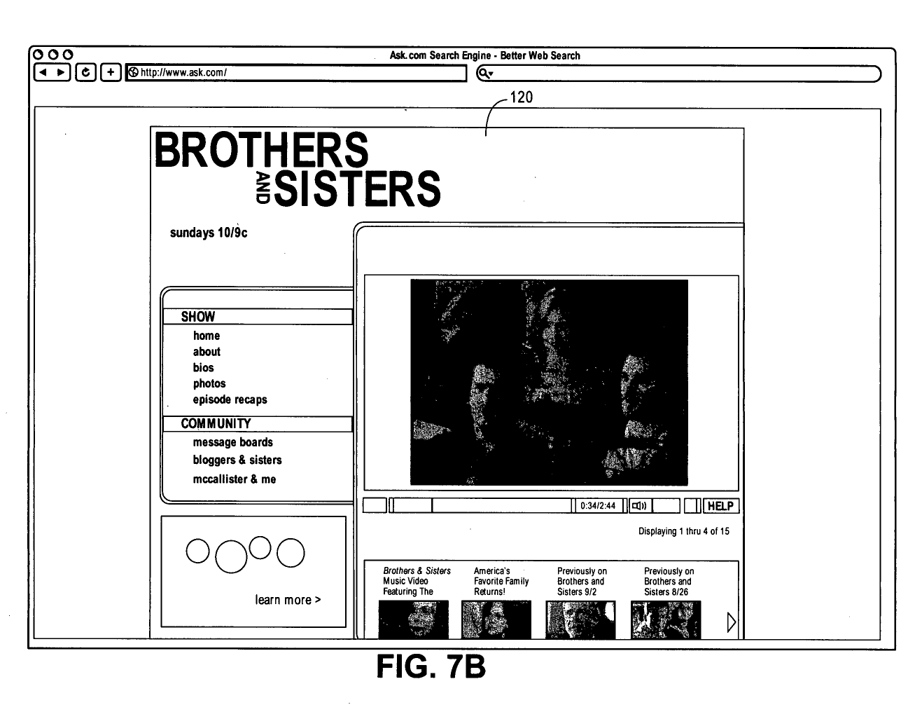

FIGS. 7A-7B illustrate yet another application of clickless selection. In FIG. 7A, user interface 114 includes a plurality of search results 116 provided to a user in response to a search query. Methods of providing search results in response to a search query are well known in the art; accordingly, these methods are not described in detail. Often, when users enter a search query, the search engine also publishes one or more advertisements 118 that may or may not be related to the search query together with the search results 116. A user can select an advertisement 118 from the user interface 114 by moving the pointer to the advertisement and maintaining the pointer over the advertisement or an area near the advertisement for a predetermined amount of time. If the user selects the advertisement 118, the user may be redirected to a website 120 associated with the advertisement 118, as shown in FIG. 7B.

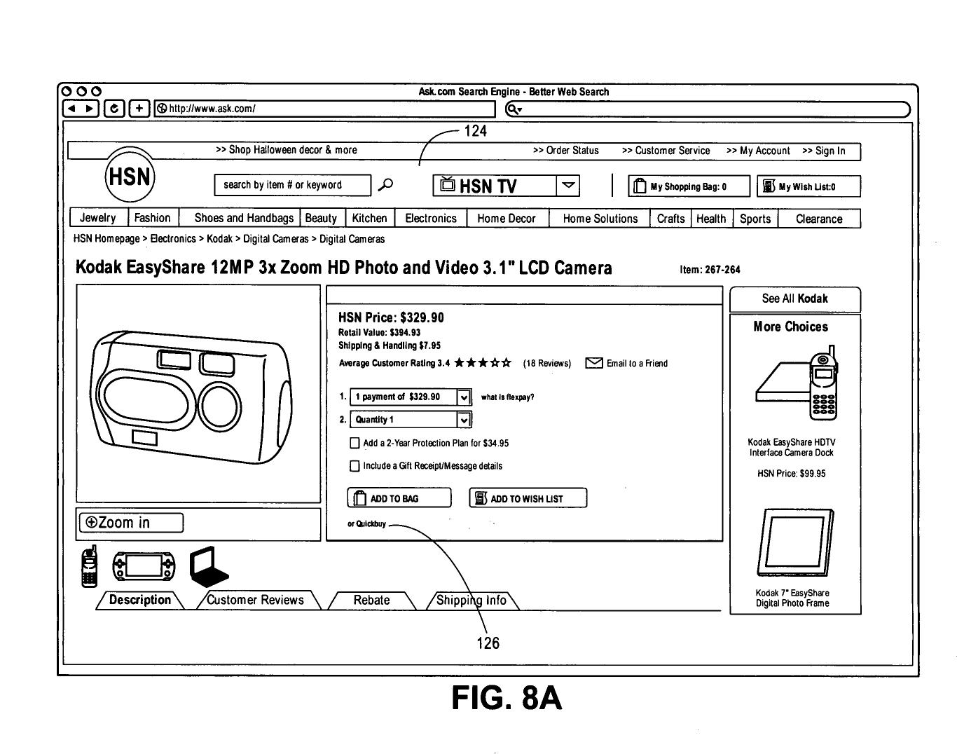

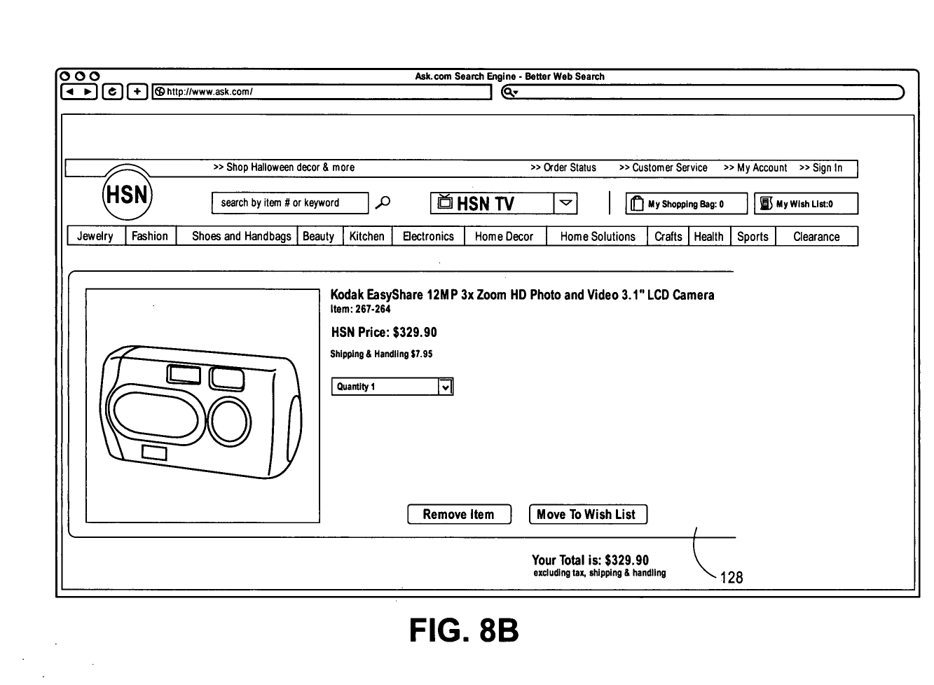

FIGS. 8A-8B illustrate still another application of clickless selection. In FIG. 8A, a user interface 124 includes information related to a product that can be purchased. The user interface 124 includes a link 126 designated by “Quickbuy.” A user can select, without clicking (i.e., mouse over), the link 126. If the user selects the link 126, the user may automatically purchase the product in the interface 128, as shown in FIG. 8B.

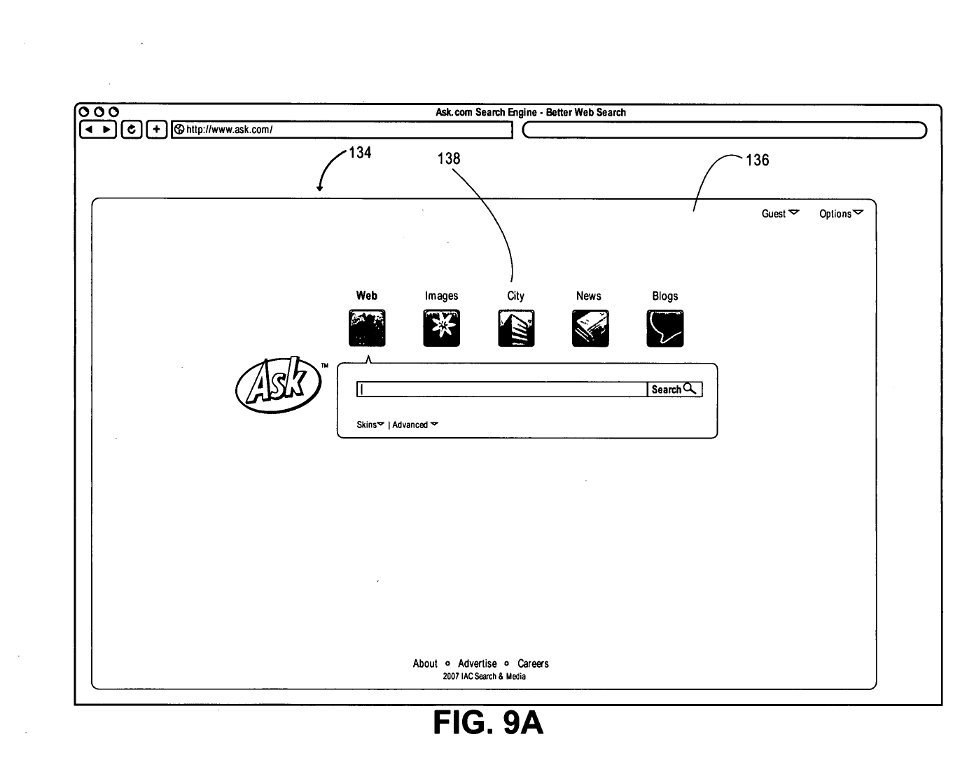

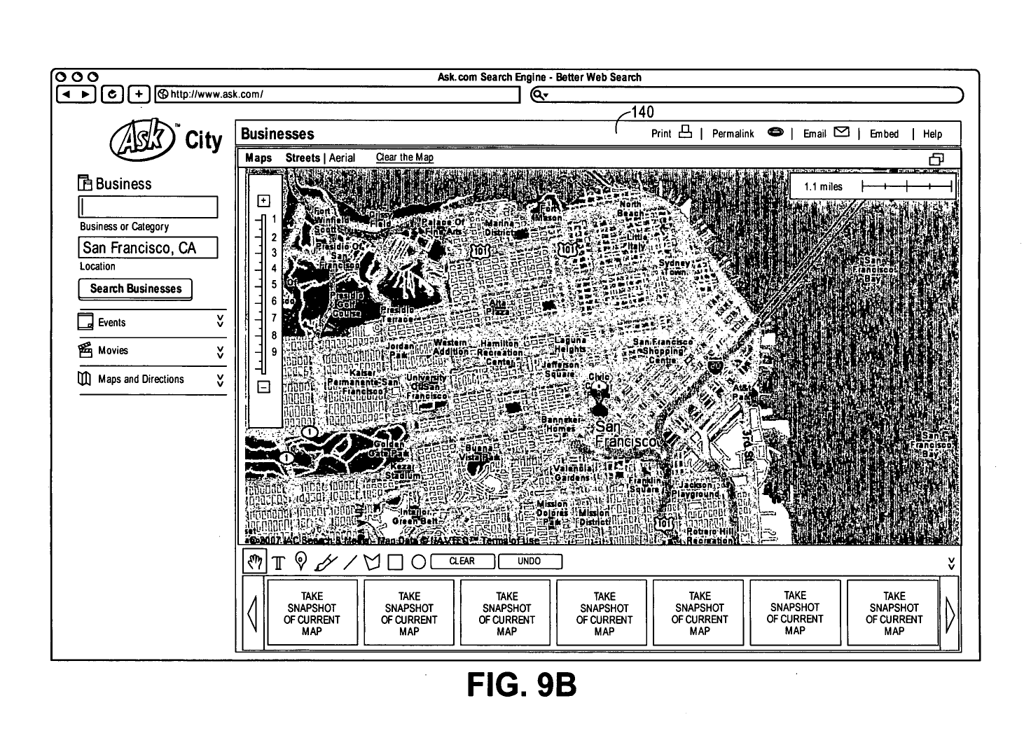

FIGS. 9A-9B illustrate another application of clickless selection. In FIG. 9A, a user interface 134 allows a user to view a webpage 136 from a website. The webpage 136 includes a link 138 to another page within the same website. A user can select, without clicking, the link 138. If the user selects the link 138, the user is redirected to the webpage 140 within the same website, as shown in FIG. 9B.

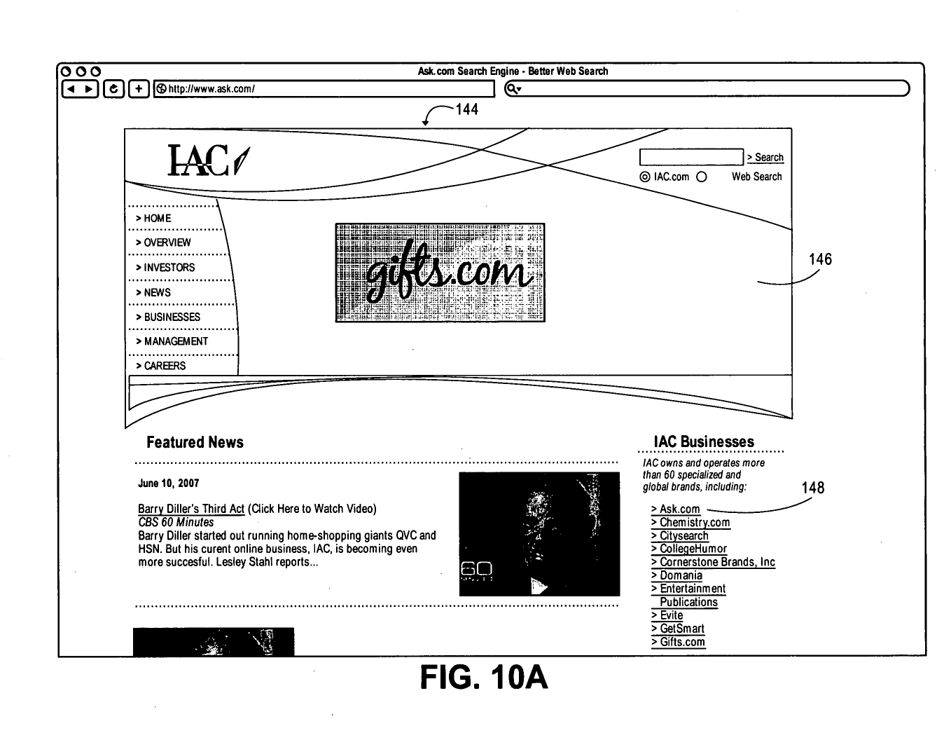

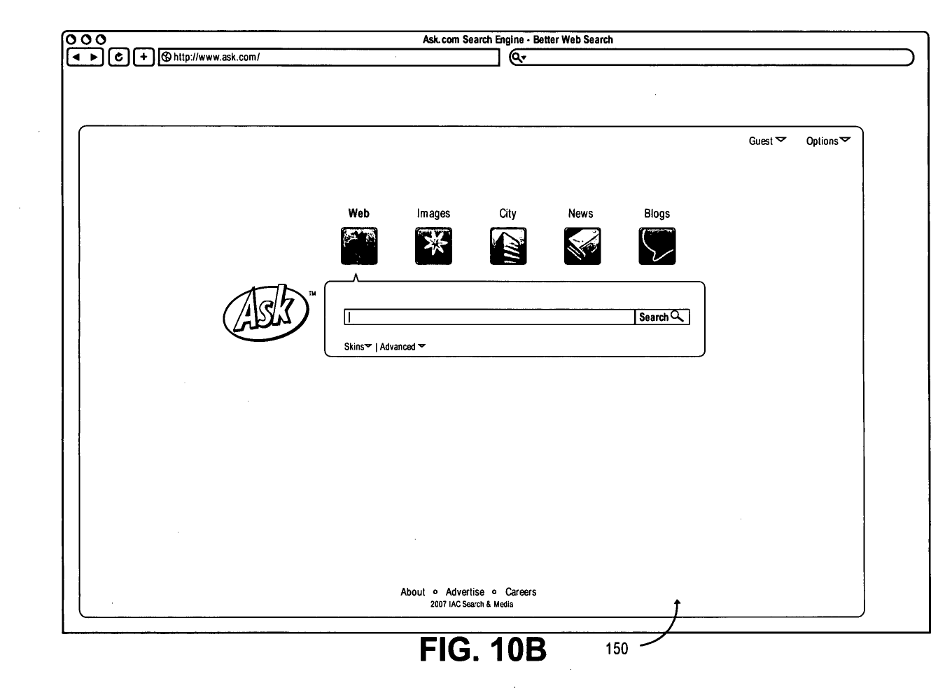

FIGS. 10A-10B illustrate a further application of clickless selection. In FIG. 10A, a user interface 144 allows a user to view a webpage 146 from a first website. The webpage 146 includes a link 148 associated with another website (i.e., second website). A user can select, without clicking, the link 148. If the user selects the link 148, the user is redirected to a webpage 150 of the second website associated with the link 148, as shown in FIG. 10B.

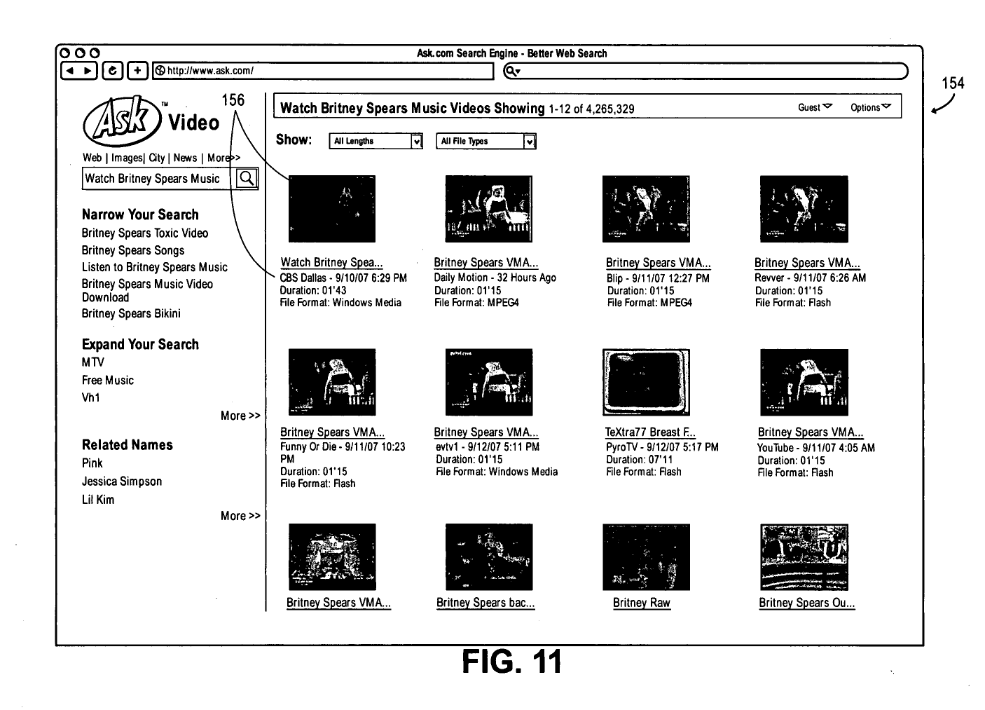

FIG. 11 illustrate a still further application of clickess selection. In FIG. 11, a user interface 154 allows a user to listen to music or watch videos. In FIG. 11, images and text 156 associated with the music and/or videos are provided in the user interface 154. A user can select, without clicking, the image and/or text 156 associated with the music and/or videos. When the user selects the music and/or videos without clicking, the music and/or videos play.

It will be appreciated that a mouse over is also applicable to holding a pointer associated with a touchpad-based system (i.e., computers without a mouse) over a link or anchor for a predetermined amount of time, as described above.

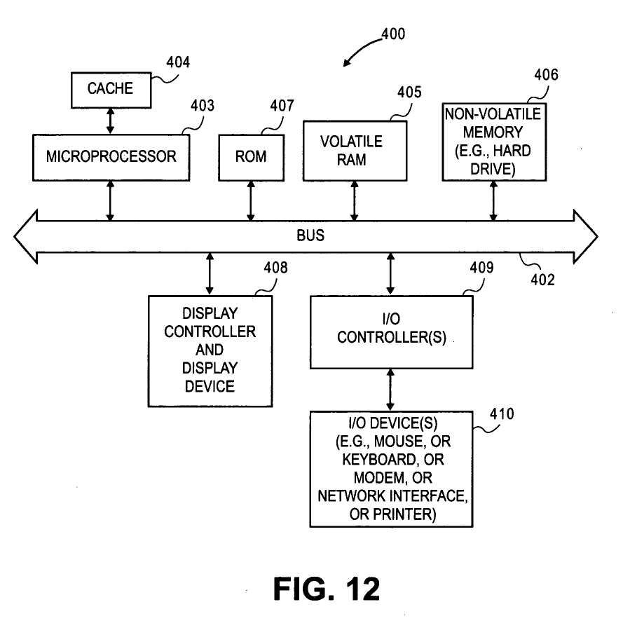

FIG. 12 is a block diagram of a digital processing system which may be used in accordance with one embodiment of the invention. Note, that while FIG. 12 illustrates various components of a computer system, it is not intended to represent any particular architecture or manner of interconnecting the components, as such details are not germane to the present invention. It will also be appreciated that network computers, handheld computers, cell phones, multimedia players, and other data processing systems which have fewer components or perhaps more components may also be used with the present invention.

As shown in FIG. 12, the processing system 400 includes a bus 402 which is coupled to a microprocessor 403 and a ROM 407, a volatile RAM 405, and a non-volatile memory 406. The microprocessor 403, which may be, for example, a PowerPC G4 or PowerPC G5 microprocessor from Motorola, Inc. or IBM, is coupled to cache memory 404 as shown in the example of FIG. 12. The bus 402 interconnects these various components together and also interconnects these components 403, 407, 405 and 406 to a display controller and display device 408, as well as to input/output (I/O) devices 410. Typically, the I/O devices 410 are coupled to the system through I/O controllers 409. The volatile RAM 405 is typically implemented as dynamic RAM (DRAM) which requires power continuously in order to refresh or maintain the data in the memory. The non-volatile memory 406 is typically a magnetic hard drive, a magnetic optical drive, an optical drive, or other type of memory system which maintains data even after power is removed from the system. Typically, the non-volatile memory will also be a random access memory, although this is not required. While FIG. 12 shows the non-volatile memory is a local device coupled directly to the rest of the components in the processing system, it will be appreciated that the present invention may utilize a non-volatile memory which is remote from the system, such as a network storage device which is coupled to the data processing system through a network interface. The bus 402 may include one or more buses connected to each other through various bridges, controllers and/or adapters, as is well-known in the art. In one embodiment, the I/O controller 409 includes a USB (Universal Serial Bus) adapter for controlling USB peripherals. Alternatively, I/O controller 409 may include an IEEE01394 adapter, also known as FireWire adapter, for controlling FireWire devices. Other components may be included.

The foregoing description with attached drawings is only illustrative of possible embodiments of the described method and should only be construed as such. Other persons of ordinary skill in the art will realize that many other specific embodiments are possible that fall within the scope and spirit of the present idea. The scope of the invention is indicated by the following claims rather than by the foregoing description. Any and all modifications which come within the meaning and range of equivalency of the following claims are to be considered within their scope.

1. A method comprising:
providing a first webpage having a selectable object therein, the selectable object being a link to a second webpage;
receiving a user selection of the selectable object, the user selection being a mouse over of the selectable object; and
providing the second webpage to the user in response to the user selection.

2. The method of claim 1, wherein the second webpage is presented in a new window.

3. The method of claim 1, wherein the user is automatically redirected from the first webpage to the second webpage in response to the user selection.

4. The method of claim 1, wherein the mouse over comprises detecting a pointer over the selectable object for a predetermined amount of time.

5. The method of claim 1, wherein the first webpage and second webpage are associated with a website.

6. The method of claim 1, wherein the first webpage is associated with a first website and the second webpage is associated with a second website.

7. A method for presenting electronic information comprising:
clustering news information according to a topic to create topic clusters, each topic cluster having a plurality of news information objects associated with the topic cluster;
presenting at least one of the news information objects associated with the topic clusters in a user interface, each presenting news information object having a selectable portion; and
receiving a user selection of the at least one of the news information objects, the user selection being a mouse over of the selectable portion.

8. The method of claim 7, further comprising presenting the user with news information associated with the selected topic clusters.

9. The method of claim 7, further comprising associating a news information object with a topic cluster.

10. The method of claim 7, wherein the topic cluster is part of a topic chain, and wherein the news information object is associated with the topic chain.

11. The method of claim 7, wherein the news information object consists essentially of a representative image and a representative title.

12. The method of claim 7, wherein the mouse over comprises detecting a pointer over the news information object for a predetermined amount of time.

13. The method of claim 8, wherein presenting comprises presenting the user with an article from a selected topic cluster.

14. The method of claim 7, wherein the selectable object is an anchor.

15. The method of claim 7, wherein the selectable object is a link to a webpage.

16. A method for presenting electronic information comprising:
allowing a user to access a collection of images, each image associated with at least one news article;
receiving a user selection of an image from the collection of images, wherein the user selection is a mouse over of the image; and
presenting the user with a plurality of news objects associated with the selected object.

17. The method of claim 16, wherein each image in the collection of images is associated with a representative title, the user selecting either or both of the one or more images or representative titles.

18. The method of claim 16, wherein presenting comprises presenting an abstract of a selected news article and a link to access the entire article.

19. The method of claim 16, wherein the mouse over comprises detecting a pointer over the image for a predetermined amount of time.

20. The method of claim 16, wherein the plurality of news objects comprise images.

21. The method of claim 16, wherein the image is an anchor.

22. The method of claim 16, wherein the image is a link to a webpage.
